(19) United States
(12) Patent Application Publication
(10) Pub. No.: US 2010/0000861 A1
(43) Pub. Date: Jan. 7, 2010

(54) PACKAGING SYSTEM FOR TESTING DEVICES

(75) Inventor: Weiping Zhong, Granger, IN (US)

Correspondence Address: NIXON PEABODY LLP, 300 S. Riverside Plaza, 16th Floor, CHICAGO, IL, 60606-6613, US

(73) Assignee: Bayer HealthCare, LLC, Tarrytown, NY (US)

(21) Appl. No.: 12/375,102

(22) PCT Filed: Jul. 30, 2007
(86) PCT No.: PCT/US07/17020

§ 371 Date: Jan. 26, 2009

Related U.S. Application Data
(60) Provisional application No. 60/834,512, filed on Jul. 31, 2006.

(51) Int. Cl. G01N 27/26; B32B 37/14

(52) U.S. Cl. 204/403.01; 156/280

(57) ABSTRACT

A packaging system is disclosed. The packaging system comprises an analyte-testing device including a fluid-receiving portion. The packaging system further comprises a film adapted to cover the fluid-receiving portion of the analyte-testing device. The film has a first side and an opposing second side. The first side is adapted to contact the analyte-testing device. The packaging system further comprises adhesive positioned on at least a portion of the first side of the film. The packaging system further comprises a desiccant material positioned on the first side of the film such that the desiccant material is adapted to be in vapor communication with the fluid-receiving portion of the analyte-testing device.

### FIELD OF THE INVENTION

The present invention relates generally to a packaging system for testing devices and, more particularly, to a packaging system for individual test sensors that are adapted to determine an analyte concentration in a fluid sample.

### BACKGROUND OF THE INVENTION

The quantitative determination of analytes in body fluids is of great importance in the diagnoses and maintenance of certain physiological abnormalities. For example, lactate, cholesterol, and bilirubin should be monitored in certain individuals. In particular, determining glucose in body fluids is important to diabetic individuals who must frequently check the glucose level in their body fluids to regulate the glucose intake in their diets. The results of such tests may be used to determine what, if any, insulin or other medication needs to be administered. In one type of testing system, test sensors are used to test a fluid such as a sample of blood.

One method of monitoring a person's blood glucose level is with a portable, hand-held blood glucose testing device (e.g., a meter). To determine the blood glucose level with the meter, a lancet device, typically containing a needle lancet, pierces the skin tissue and allows a whole blood sample to form on the skin's surface. Once the requisite amount of blood is produced on the skin's surface, the blood sample is transferred to a test sensor. In an electrochemical test sensor application, the test sensor is generally placed within an opening in the body of the meter, where an electrical signal indicative of the blood glucose level being tested is supplied and transmitted to an electrical assembly within the meter. Other types of test sensors may also be used to assist in monitoring blood glucose levels, including, for example, optical test sensors.

Many individuals test their blood glucose several times per day. Because of the frequency of testing, the individuals often test their blood glucose at different locations including their homes, places of employment (e.g., office buildings or work sites), places of recreation, or the like. Thus, these individuals often must carry with them various analyte-testing instruments, including a meter, test sensors, a lancing device, disposable lancets, a syringe, insulin, oral medication, tissues, combinations thereof, or the like. Carrying the meter and/or other analyte-testing instruments to these various locations may be inconvenient for the individual. The inconvenience is amplified by the fact that, oftentimes, the instruments may be large, bulky, and/or heavy.

Test sensors, for example, are typically packaged in bottles, sealed bags, cartridges, or the like, each of which may contain about 25-30 test sensors. Existing test sensor packaging systems generally include one or more desiccant compartments to inhibit or prevent excess humidity from damaging the test sensor and/or altering the test results. The desiccant compartments often cause these existing packaging systems to be relatively large and/or bulky. Once removed from the bottle, sealed bag, cartridge, or the like, individual test sensors are generally not protected from excess humidity and/or contamination. Thus, individual test sensors are generally not carried around by a user. Rather, the user typically carries the entire bottle, sealed bag, cartridge, or the like to various testing locations, which may be inconvenient for the user. Another drawback to existing test sensor packaging systems is that a substantial amount of material is often required to manufacture the packaging systems, thus increasing manufacturing costs.

It would be desirable to have a packaging system for individual test sensors and other testing devices that assists in addressing one or more of the above disadvantages.

### SUMMARY OF THE INVENTION

According to one embodiment of the present invention, a packaging system is disclosed. The packaging system comprises an analyte-testing device including a fluid-receiving portion. The packaging system further comprises a film adapted to cover the fluid-receiving portion of the analyte-testing device. The film has a first side and an opposing second side. The first side is adapted to contact the analyte-testing device. The packaging system further comprises adhesive positioned on at least a portion of the first side of the film. The packaging system further comprises a desiccant material positioned on the first side of the film such that the desiccant material is adapted to be in vapor communication with the fluid-receiving portion of the analyte-testing device.

According to one process of the present invention, a method of making a packaging system is disclosed. The method comprises the act of providing an analyte-testing device including a fluid-receiving portion. The method further comprises the act of providing a film adapted to cover the fluid-receiving portion of the analyte-testing device. The film has a first side and an opposing second side. The first side is adapted to contact the analyte-testing device. The method further comprises the act of melting a desiccant material and an adhesive to form a hot-melt desiccant. The method further comprises the act of applying the hot-melt desiccant to a portion of the first side of the film such that the desiccant material is in vapor communication with the fluid-receiving portion of the analyte-testing device.

According to another process of the present invention, a method of making a packaging system is disclosed. The method comprises the act of providing an analyte-testing device including a fluid-receiving portion. The method further comprises the act of providing a film adapted to cover at least the fluid-receiving portion of the analyte-testing device. The film has an inner portion and an outer portion. The method further comprises the act of applying an adhesive to the outer portion of the film. The adhesive forms a seal around the fluid-receiving portion. The method further comprises the act of providing a desiccant material positioned within the inner portion.

According to another embodiment of the present invention, a packaging system for an individual analyte-testing device including a fluid-receiving portion is disclosed. The packaging system comprises a film adapted to cover the fluid-receiving portion of the analyte-testing device. The film has a first side and an opposing second side. The first side is adapted to contact the analyte-testing device. The packaging system further comprises adhesive positioned on at least a portion of the first side of the film. The packaging system further comprises a desiccant material positioned on the first side of the film such that the desiccant material is adapted to be in vapor communication with the fluid-receiving portion of the analyte-testing device.

The above summary of the present invention is not intended to represent each embodiment or every aspect of the present invention. Additional features and benefits of the present invention are apparent from the detailed description and figures set forth below.

### BRIEF DESCRIPTION OF THE DRAWINGS

FIG. 1a is a top view of a test sensor according to one embodiment.

FIG. 1b is a side view of the test sensor of FIG. 1a.

FIG. 2 is a top view of a packaging system for a test sensor, according to one embodiment of the present invention.

FIG. 3a is a top view of the test sensor of FIGS. 1a, 1b including the packaging system of FIG. 2.

FIG. 3b is a side view of the test sensor and packaging system of FIG. 3a.

FIG. 4 is a top view of a packaging system for a test sensor, according to another embodiment of the present invention.

### DESCRIPTION OF ILLUSTRATED EMBODIMENTS

The present invention is directed to a packaging system adapted to be used with individual test sensors or other analyte-testing devices.

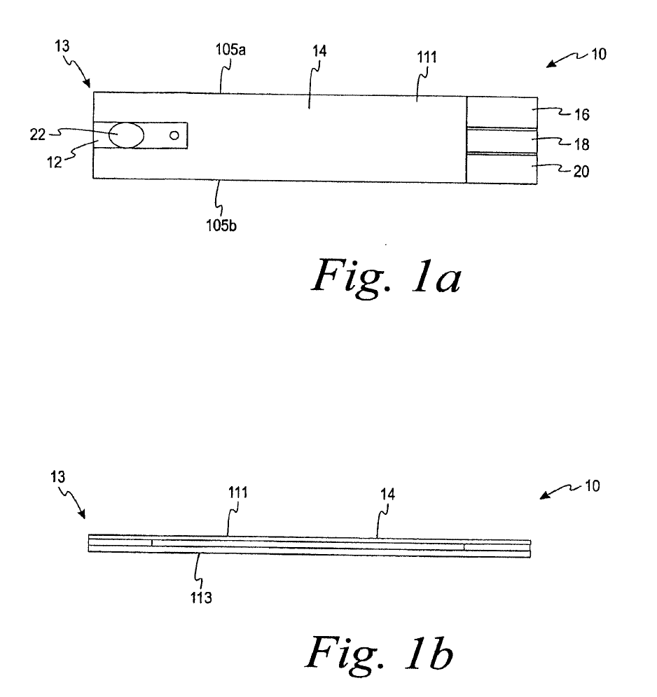

Referring to the drawings, and initially to FIGS. 1a, 1b, one non-limiting example of a test sensor 10 is shown. The test sensor 10 may be used with an analyte-testing instrument or meter to assist in determining an analyte concentration in a fluid sample. Some examples of the types of analytes that may be collected and analyzed include glucose, lipid profiles (e.g., cholesterol, triglycerides, LDL, and HDL), creatine, creatinine, urea, microalbumin, fructose, lactate, or bilirubin. The present invention is not limited, however, to test sensors used for testing the concentration of these specific analytes, and it is contemplated that other analyte concentrations may be determined. The analytes may be in, for example, a whole blood sample, a blood serum sample, a blood plasma sample, or other body fluids like ISF (interstitial fluid) and/or urine. One non-limiting example of a use for the test sensor 10 is to assist in determining the glucose concentration in a user's blood, plasma, or ISF.

The test sensor 10 generally includes a capillary channel 12 located at a fluid-receiving or testing end 13 of the test sensor 10, a lid 14, and a plurality of electrodes 16, 18, 20. The plurality of electrodes generally includes a counter electrode 16, a detection electrode 18, and a working (measuring) electrode 20. It is contemplated that other combinations of electrodes may be used as well as a different number of electrodes. As shown in FIG. 1a, the test sensor 10 further includes a fluid-receiving area 22 that contains reagent. The operation of the fluid-receiving area with reagent and the electrodes on the test sensors is known to those skilled in the art and will, therefore, not be described in further detail. Examples of electrochemical test sensors, including their operation, may be found at, for example, U.S. Pat. No. 6,531,040.

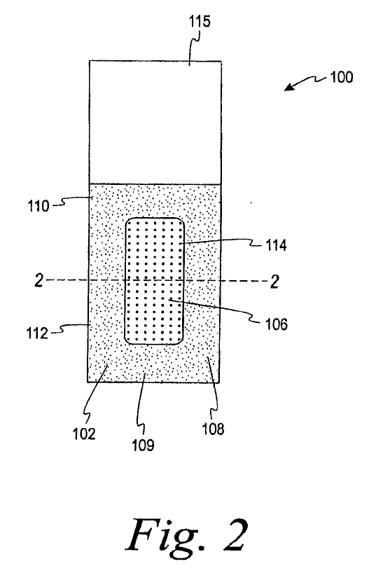

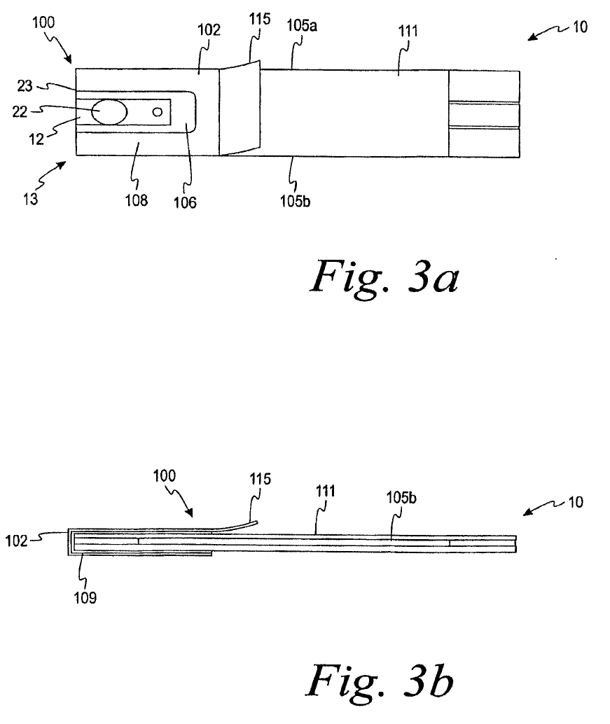

Referring now to FIG. 2, a packaging system 100, according to one embodiment of the present invention, is shown. FIGS. 3a, 3b illustrate the packaging system 100 being used with the test sensor 10 of FIGS. 1a, 1b. According to the illustrated embodiment, the packaging system 100 includes a piece of film 102 having a tab portion 115. As shown in FIGS. 3a, 3b, the packaging system 100 is generally placed over the testing end 13 of the test sensor 10 to protect the test sensor 10 (e.g., the fluid-receiving portion 22 containing the reagent) from excess humidity, contaminants, or the like.

Referring to FIGS. 2 and 3a, the film 102 may be made of a polymeric material, metalized plastic film, waxed paper, other suitable materials, or combinations thereof. The film 102 should be able to withstand pulling forces, which may range from about 0.1 lbs. to about 5 lbs., depending on the film-sensor sealing requirements. The material used to form the film 102 should be generally impervious to humidity and other materials (e.g., contaminants) that may be harmful to the test sensor 10. The dimensions of the film 102 will typically vary based on the dimensions of the test sensor 10 with which the film 102 is to be used. For example, the film 102 may have a length L generally ranging from about 30 mm to about 50 mm and a width generally ranging from about 5 mm to about 10 mm.

According to the embodiment of FIGS. 2 and 3a, an outer portion 108 of the film 102 includes an adhesive 109 on a side of the film 102 adapted to contact the test sensor 10. The adhesive 109 may be placed on the entire outer portion 108 or a portion(s) thereof. The outer portion 108 thus serves as a seal to assist in inhibiting humidity and/or contaminants from damaging the test sensor 10 and/or the components of the test sensor 10. The thickness T of the outer portion 108 may vary depending on the desired expected lifetime of the test sensor 10. For example, a larger thickness T provides a thicker seal and is, therefore, generally more effective in inhibiting humidity and/or contaminants from seeping in through the seal than a smaller thickness T.

It may be desirable that an inner portion 106 of the film 102 be kept generally free of adhesive 109 to avoid potential damage to the test sensor 10 caused by the adhesive 109 and/or film 102 adhering to portions (e.g., the capillary channel 12 and/or the fluid-receiving area 22) of the test sensor 10, thereby possibly altering the test results. It is contemplated, however, that adhesive 109 may be applied to the inner portion 106 of the film if, for example, the adhesive 109 generally does not adhere to and/or damage the test sensor 10.

The packaging system 100 further includes a desiccant material. The desiccant material assists in ensuring that the test sensor 10 is maintained at an appropriate humidity level so that the reagent material in the fluid-receiving portion 22 of the test sensor 10 is not adversely affected prior to being used.

According to the embodiment of FIGS. 2 and 3a, a desiccant material 114 is located on or adjacent to the inner portion 106 of the film 102. The desiccant material 114 might be in the form of a powder, a pellet, a bead, or any other form that may be readily disposed in or adjacent to the inner portion 106 of the film 102. The amount of desiccant material 114 used depends on the amount required to maintain the test sensor 10 in a desiccate state. One non-limiting type of desiccant material that may be used is 13X synthetic molecular sieves from Multisorb Technologies, Inc. (Buffalo, N.Y.), available in powder, pellet, and bead forms.

According to another embodiment, the desiccant material 114 is melted, and the melted desiccant material 114 is applied to the inner portion 106 of the film 102. The desiccant material 114 may be applied to the inner portion 106 such that the desiccant material 114 adheres to the film and sets as it cools. Once the desiccant material 114 has cooled and set on the film 102, it generally does not adhere to the test sensor 10. The desiccant material 114 generally does not contact the test-sensor opening and/or the chemical materials on the test sensor 10. The desiccant material 114 may be located over the entire inner portion 106 or any portion(s) thereof.

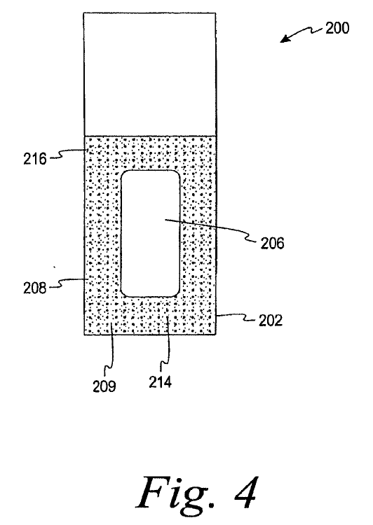

FIG. 4 shows a packaging system 200 according to another embodiment of the present invention. The packaging system 200 is generally similar to the packaging system 100 of FIGS. 2 and 3a. According to the embodiment of FIG. 4, a desiccant material 214 is positioned on an outer portion 208 of a film 202. According to the embodiment of FIG. 4, the desiccant material 214 may be melted and mixed with an adhesive 209 to form a hot-melt desiccant 216. The hot-melt desiccant 216 may then be applied on the outer portion 208 of the film 202 such that vapor communication between the desiccant material 214 and the test sensor (e.g., test sensor 10) exists and the desiccant material 214 may properly maintain the humidity of the test sensor. The desiccant material 214 may be located over the entire outer portion 208 or any portion(s) thereof.

The desiccant material 214 may be applied to the outer portion 208 instead of or in addition to applying desiccant material 214 to an inner portion 206, as described above with respect to FIGS. 2 and 3a. Thus, it is contemplated that, according to another embodiment of the present invention, the desiccant material 214 may be positioned in or adjacent to the outer portion 208 and the inner portion 206. One or more forms of the desiccant material 214 (e.g., powder, pellet, bead, hot-melt) may be used in either or both portions 206, 208.

As shown in the illustrated embodiments, the film 102 is folded generally along a line 2-2 (see FIG. 2) and wrapped around a bottom edge 23 of the testing end 13 of the test sensor 10. Thus, a portion 110 of the film 102 above the line 2-2 (see FIG. 2) is positioned over a top 111 of the test sensor 10 (see FIGS. 3a, 3b), and a portion 112 below the line 2-2 is positioned on a bottom 113 of the test sensor 10. The line 2-2 may be generally through the center of the outer portion 108 and the inner portion 106. It is contemplated that the line 2-2 may also be generally through other portions of the film 102.

Alternatively or additionally, the film 102 may wrap around one or both sides 105a, 105b of the test sensor 10. Although this may not be necessary, as the test sensor 10 is typically sealed at its sides 105a, 105b during manufacture of the test sensor 10, it may provide added protection from humidity and/or contamination. It is also contemplated that the film may not wrap around the sensor but, rather, the film may be placed only on either the top 111 or the bottom 113 of the test sensor 10. How and/or where the film 102 is positioned on the test sensor 10 may depend on where the portions of the test sensor 10 (e.g., the fluid-receiving area 22) that require protection from humidity and/or contamination are located.

As shown in the embodiments of FIGS. 2, 3a, and 3b, the packaging system 100 may also include a tab portion 115. The tab portion 115 is generally free of adhesive 109 such that the tab portion 115 may be readily grasped and pulled by a user to remove the film 102 from the test sensor 10 prior to using the test sensor 10. The tab portion 115 is generally large enough for a user to readily grasp and may have any suitable shape. The tab portion 115 generally extends from the film 102. Thus, the tab portion 102 may be integral to the film 102 and, thus, comprised of the same material as the film 102, or it may be a separate portion attached to the film 102 using any suitable attachment means. In other embodiments of the present invention, the packaging system 100 may not include a tab portion 115.

Packaging individual test sensors according to the present invention may increase user satisfaction and convenience by allowing the user to carry only as many individually packaged test sensors as are needed. Thus, the need for the user to carry a larger package adapted to hold multiple test sensors may be substantially reduced or eliminated.

While the present invention has been described and illustrated in connection with electrical biosensors, the present invention is applicable to other types of test sensors including, for example, optical test sensors. Examples of optical test sensors and the operation thereof may be found at, for example, U.S. Pat. No. 5,194,393. It is contemplated that the present invention may also be used with other test sensor configurations.

It is also contemplated that the packaging system of the present invention may be used with other analyte-testing devices that include humidity and/or light sensitive testing components and/or reagents. One non-limiting example of a device that may utilize the packaging system of the present invention includes a urine strip. The packaging system of the present invention may be used with test reagent cartridges or strips for testing HbA1C and/or other analytes. Regardless of the type of sensor or device used in connection with the present invention, the present invention provides the described advantages to the overall testing processes.

### ALTERNATIVE EMBODIMENT A

A packaging system comprising:
an analyte-testing device including a fluid-receiving portion;
a film adapted to cover the fluid-receiving portion of the analyte-testing device, the film having a first side and an opposing second side, the first side being adapted to contact the analyte-testing device;
adhesive positioned on at least a portion of the first side of the film; and
a desiccant material positioned on the first side of the film such that the desiccant material is adapted to be in vapor communication with the fluid-receiving portion of the analyte-testing device.

### ALTERNATIVE EMBODIMENT B

The packaging system of alternative embodiment A, wherein the analyte-testing device is an electrochemical test sensor.

### ALTERNATIVE EMBODIMENT C

The packaging system of alternative embodiment A, wherein the film comprises plastic, metalized plastic film, waxed paper, or a combination thereof.

### ALTERNATIVE EMBODIMENT D

The packaging system of alternative embodiment A further comprising a tab portion extending from an end of the film, the tab portion having substantially no adhesive thereon.

### ALTERNATIVE EMBODIMENT E

The packaging system of alternative embodiment A, wherein the film has an outer portion and an inner portion, the adhesive being positioned on the outer portion of the film.

### ALTERNATIVE EMBODIMENT F

The packaging system of alternative embodiment E, wherein the desiccant material is positioned in an inner portion of the film.

### ALTERNATIVE EMBODIMENT G

The packaging system of alternative embodiment E, wherein the desiccant material is mixed with the adhesive on the outer portion of the film.

### ALTERNATIVE EMBODIMENT H

A method of making a packaging system, the method comprising the acts of:
providing an analyte-testing device including a fluid-receiving portion;
providing a film adapted to cover the fluid-receiving portion of the analyte-testing device, the film having a first side and an opposing second side, the first side being adapted to contact the analyte-testing device;
melting a desiccant material and an adhesive to form a hot-melt desiccant; and
applying the hot-melt desiccant to a portion of the first side of the film such that the desiccant material is in vapor communication with the fluid-receiving portion of the analyte-testing device.

### ALTERNATIVE EMBODIMENT I

The method of alternative embodiment H, wherein the analyte-testing device is an electrochemical test sensor.

### ALTERNATIVE EMBODIMENT J

The method of alternative embodiment H, wherein the film comprises plastic, metalized film, waxed paper, or a combination thereof.

### ALTERNATIVE EMBODIMENT K

The method of alternative embodiment H, wherein the film includes a tab portion extending from an end of the film, the tab portion having substantially no adhesive thereon.

### ALTERNATIVE EMBODIMENT L

The method of alternative embodiment H, wherein the portion of the first side of the film includes an outer portion of the film, the outer portion forming a seal.

### ALTERNATIVE EMBODIMENT M

A method of making a packaging system, the method comprising the acts of:
providing an analyte-testing device including a fluid-receiving portion;
providing a film adapted to cover at least the fluid-receiving portion of the analyte-testing device, the film having an inner portion and an outer portion;
applying an adhesive to the outer portion of the film, the adhesive forming a seal around the fluid-receiving portion;
providing a desiccant material positioned within the inner portion.

### ALTERNATIVE EMBODIMENT N

The method of alternative embodiment M, wherein the analyte-testing device is an electrochemical test sensor.

### ALTERNATIVE EMBODIMENT O

The method of alternative embodiment M, wherein the film comprises plastic, metalized film, waxed paper, or a combination thereof.

### ALTERNATIVE EMBODIMENT P

The method of alternative embodiment M, wherein the film includes a tab portion extending from an end of the film, the tab portion having substantially no adhesive thereon.

### ALTERNATIVE EMBODIMENT Q

The method of alternative embodiment M, wherein the desiccant material is in the form of a powder, a pellet, or a bead.

### ALTERNATIVE EMBODIMENT R

A packaging system for an individual analyte-testing device, the analyte-testing device including a fluid-receiving portion, the packaging system comprising:
a film adapted to cover the fluid-receiving portion of the analyte-testing device, the film having a first side and an opposing second side, the first side being adapted to contact the analyte-testing device;
adhesive positioned on at least a portion of the first side of the film; and
a desiccant material positioned on the first side of the film such that the desiccant material is adapted to be in vapor communication with the fluid-receiving portion of the analyte-testing device.

### ALTERNATIVE EMBODIMENT S

The packaging system of alternative embodiment R, wherein the film has an outer portion and an inner portion, the adhesive being positioned on the outer portion of the film.

### ALTERNATIVE EMBODIMENT T

The packaging system of alternative embodiment S, wherein the desiccant material is positioned in an inner portion of the film.

### ALTERNATIVE EMBODIMENT U

The packaging system of alternative embodiment S, wherein the desiccant material is mixed with the adhesive on the outer portion of the film.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents, and alternatives falling within the spirit and scope of the invention as defined by the appended claims.

1. A packaging system comprising:
an analyte-testing device including a fluid-receiving portion;
a film adapted to cover the fluid-receiving portion of the analyte-testing device, the film having a first side and an opposing second side, the first side being adapted to contact the analyte-testing device;
adhesive positioned on at least a portion of the first side of the film; and
a desiccant material positioned on the first side of the film such that the desiccant material is adapted to be in vapor communication with the fluid-receiving portion of the analyte-testing device.

2. The packaging system of claim 1, wherein the analyte-testing device is an electrochemical test sensor.

3. The packaging system of claim 1, wherein the film comprises plastic, metalized plastic film, waxed paper, or a combination thereof.

4. The packaging system of claim 1, further comprising a tab portion extending from an end of the film, the tab portion having substantially no adhesive thereon.

5. The packaging system of claim 1, wherein the film has an outer portion and an inner portion, the adhesive being positioned on the outer portion of the film.

6. The packaging system of claim 5, wherein the desiccant material is positioned in an inner portion of the film.

7. The packaging system of claim 5, wherein the desiccant material is mixed with the adhesive on the outer portion of the film.

8. A method of making a packaging system, the method comprising the acts of:
providing an analyte-testing device including a fluid-receiving portion;
providing a film adapted to cover the fluid-receiving portion of the analyte-testing device, the film having a first side and an opposing second side, the first side being adapted to contact the analyte-testing device;
melting a desiccant material and an adhesive to form a hot-melt desiccant; and
applying the hot-melt desiccant to a portion of the first side of the film such that the desiccant material is in vapor communication with the fluid-receiving portion of the analyte-testing device.

9. The method of claim 8, wherein the analyte-testing device is an electrochemical test sensor.

10. The method of claim 8, wherein the film comprises plastic, metalized film, waxed paper, or a combination thereof.

11. The method of claim 8, wherein the film includes a tab portion extending from an end of the film, the tab portion having substantially no adhesive thereon.

12. The method of claim 8, wherein the portion of the first side of the film includes an outer portion of the film, the outer portion forming a seal.

13. A method of making a packaging system, the method comprising the acts of:
providing an analyte-testing device including a fluid-receiving portion;
providing a film adapted to cover at least the fluid-receiving portion of the analyte-testing device, the film having an inner portion and an outer portion;
applying an adhesive to the outer portion of the film, the adhesive forming a seal around the fluid-receiving portion;
providing a desiccant material positioned within the inner portion.

14. The method of claim 13, wherein the analyte-testing device is an electrochemical test sensor.

15. The method of claim 13, wherein the film comprises plastic, metalized film, waxed paper, or a combination thereof.

16. The method of claim 13, wherein the film includes a tab portion extending from an end of the film, the tab portion having substantially no adhesive thereon.

17. The method of claim 13, wherein the desiccant material is in the form of a powder, a pellet, or a bead.

18. A packaging system for an individual analyte-testing device, the analyte-testing device including a fluid-receiving portion, the packaging system comprising:
a film adapted to cover the fluid-receiving portion of the analyte-testing device, the film having a first side and an opposing second side, the first side being adapted to contact the analyte-testing device;
adhesive positioned on at least a portion of the first side of the film; and
a desiccant material positioned on the first side of the film such that the desiccant material is adapted to be in vapor communication with the fluid-receiving portion of the analyte-testing device.

19. The packaging system of claim 18, wherein the film has an outer portion and an inner portion, the adhesive being positioned on the outer portion of the film.

20. The packaging system of claim 19, wherein the desiccant material is positioned in an inner portion of the film.

21. The packaging system of claim 19, wherein the desiccant material is mixed with the adhesive on the outer portion of the film.
